(19) United States
(12) Patent Application Publication
(10) Pub. No.: US 2012/0174911 A1
(43) Pub. Date: Jul. 12, 2012

(54) SOLAR COLLECTOR

(76) Inventor: Andrea Pedretti, Bellinzona (CH)

(21) Appl. No.: 13/120,107

(22) PCT Filed: Sep. 29, 2009
(86) PCT No.: PCT/CH2009/000310

§ 371 Date: Mar. 27, 2012

(30) Foreign Application Priority Data
Sep. 30, 2008 (CH) 1559/08
Oct. 1, 2008 (CH) 1566/08

(51) Int. Cl. F24J 2/24; B23P 15/26; G02B 7/188

(52) U.S. Cl. 126/651; 359/847; 29/890.033

(57) ABSTRACT

The solar collector according to the invention has a membrane arrangement 41 comprising zones 70, 71, 72 having different spherical curvature in such a manner that their concentrator membrane 42 which is covered with a reflecting layer is optimally approximated to a parabolic shape and therefore has an optimally small focal point or focal line region.

The present invention relates to a radiation collector according to claim 1.

Radiation collectors or concentrators of the said type are used, inter alia, in solar power plants.

So far, on account of the disadvantages of photovoltaic methods which have not yet been surmounted, it has not been possible to generate solar power using this technology in a manner that approximately covers costs. Solar thermal power plants, on the other hand, have already been producing power on an industrial scale for some time at prices which, compared to photovoltaic methods, are close to the commercial prices now usual for power produced in the conventional manner.

In solar thermal power plants, the sun's radiation is reflected by collectors with the aid of a concentrator and is specifically focussed onto a location at which high temperatures are thereby produced. The concentrated heat can be removed and used for operating thermal machines such as turbines which in turn drive power-generating generators.

Three basic forms of solar thermal power plants are in use today: dish Stirling systems, solar tower power plant systems and parabolic trough systems.

Dish Stirling systems are fitted with parabolic mirrors which concentrate the sunlight to a focal point, where a heat receiver is located. The mirrors are mounted so that they are biaxially rotatable in order to be able to track the current position of the Sun and have a diameter of a few metres up to 10 m and more, with the result that powers of up to 50 kW per module are achieved. A Stirling motor installed at the heat receiver converts the thermal energy directly into mechanical work as a result of which current is in turn generated.

At this point, reference is made to the embodiments presented in U.S. Pat. No. 4,543,945 and the EU Distal and Eurodish installations installed in Spain.

U.S. Pat. No. 4,543,945 discloses in a first embodiment a construction principle of a collector comprising a pressure cell consisting of two round superposed membranes connected at the sides, wherein the upper membrane is configured to be transparent and the lower membrane is provided with a reflecting layer. In the inflated state the pressure cell has a lens shape, wherein both membranes are spherically curved with the result that the radiation incident through the transparent part is concentrated by the reflecting layer into a region where the heat can be removed. In a second embodiment, a vacuum cell is used instead of the pressure cell so that the membrane with the reflecting layer is brought into a spherical operating position by the ambient pressure.

The Distal I and Distal II plants (which came into operation in 1992 and 1997 respectively) have concentrators mounted in a framework which are spanned as extendable membranes on the framework and are held in the operating position by means of a vacuum pump. In principle, the framework forms a sealed cavity which is spanned by the membrane, as is the case with the membrane of the drum. The membrane forming the concentrator is sucked into the framework by means of the vacuum generated by the vacuum pump (or pressed into the framework from outside by the ambient pressure) and then acquires a substantially spherical shape but close to paraboloid—the operating position. Distal II has a mirror or a concentrator diameter of 8.5 m.

The use of a membrane has the advantage of low weight which in turn leads to low expenditure for the framework on which the membrane is spanned. The construction expenditure is significantly lower compared with a conventional heavy mirror which is expensive to manufacture.

Solar tower power plant systems have a central absorber mounted in an elevated manner (on the “tower”) for the hundreds to thousands of individual mirrors, with sunlight reflected to them, with the result that the Sun's radiation energy is concentrated via the many mirrors or concentrators in the absorber and temperatures up to 1300° C. are thus achieved, which is favourable for the efficiency of the downstream thermal machines (usually a steam or fluid turbine power plant for power generation). The “Solar two” plant in California has a power of several megawatts.

Parabolic trough power plants have a large number of collectors which have long concentrators having small transverse dimensions and therefore do not have a focal point but a focal line. These line concentrators today have a length of 20 m to 150 m. An absorber line for the concentrated heat (up to around 500° C.) runs in the focal line, which transports this to the power plant. Thermal oil or superheated water can be considered as transport medium.

The 9 SEGS trough power plants in Southern California together produce a power of about 350 MW. The “Nevada Solar One” power plant which went onto the grid in 2007 has trough collectors with 182,400 curved mirrors which are arranged on an area of 140 hectares and produce 65 MW.

Another example of a trough power plant is the Andasol 1 under construction in Andalusia having a concentrator area of 510,000 m² and 50 MW power, where the temperature in the absorber lines should reach about 400° C. The costs are estimated at three hundred million Euro. Likewise, Andasol 2 which should go onto the grid in 2009 and the projected Andasol 3.

According to rough calculations, it can be noted that 40% or more of the total costs for a solar power plant are attributed to the collectors and the efficiency of the power plant is crucially determined by the quality of the concentrators.

WO 2008/037108 is now proposing collectors, in particular trough collectors whose concentrators have a coated membrane. They are suitable for industrial use in the aforesaid order of magnitude and achieve the desired advantages such as, for example, simple structure and reduced costs.

Due to the unavoidably spherically curved concentrators, however, losses of efficiency are obtained compared with the conventionally fabricated mirrors with parabolic curvature. Accordingly, in an additional embodiment, the concentrator is designed to be exposed to different pressures in sections so that its inner zone is more severely curved compared with the adjoining outer zones with the result that an approximation to the parabolic shape is obtained and thus the focal line region is an improved approximation to the theoretical focal line of a parabolic trough collector.

The pressure zones are separated by means of sealing lips or semi-transparent foam strips which allows a “sufficient sealing” without “mechanically impairing” the concentrator. Due to the contact between the sealing arrangement and the concentrator consisting of a thin, extensive membrane, a distortion of the spherical membrane curvature is unavoidably and disadvantageously achieved, resulting in an even further deterioration in the concentration of the solar radiation. As a result, the efficiency then falls further than could be improved by the zones of different curvature.

The disclosed sufficient sealing which is intended to avoid any mechanical impairment causes a continuous leakage air flow so that the concentrator floats on the sealing arrangement (and is therefore uniformly stressed over its entire area), the leakage air flow in turn being continuously compensated by a rotating fan.

In fact, however, the mechanical impairment can also occur even with mechanical contact due to the air intentionally flowing through and over the sealing arrangement so that ultimately problems are obtained with actually obtaining a common focal line region of the differently curved sections and sealing the adjacently located pressure zones to the correct extent.

Accordingly, it is the object of the present invention to provide an improved collector with a concentrator membrane.

This object is achieved by a radiation collector having the features of claim 1.

By varying the line tension effective for the curvature of the concentrator membrane, a mechanical influencing is achieved which does not result in undesired distortion but to the desired result, i.e. improved concentration of the solar radiation.

Embodiments of the present invention are described in the dependent claims.

The invention is explained in detail hereinafter with reference to the figures.

In the figures:

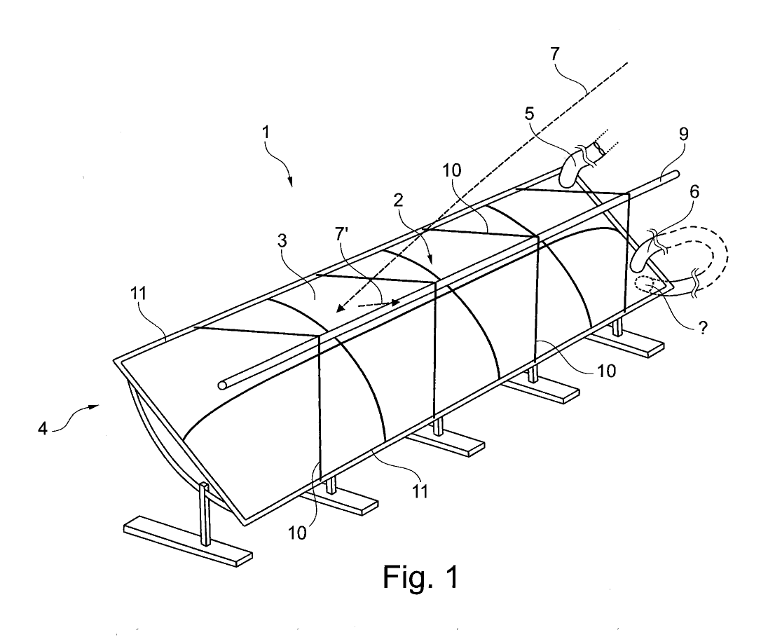

FIG. 1 shows a view of a prior-art trough collector,

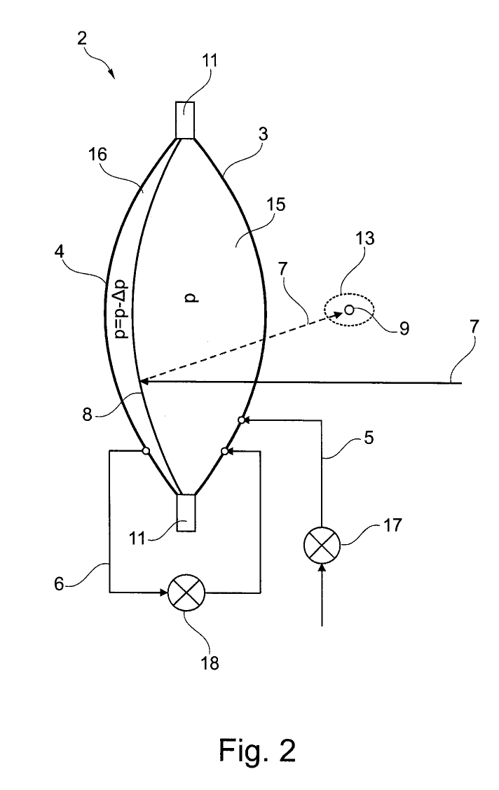

FIG. 2 shows schematically a cross-section through the pressure cell of the trough collector from FIG. 1,

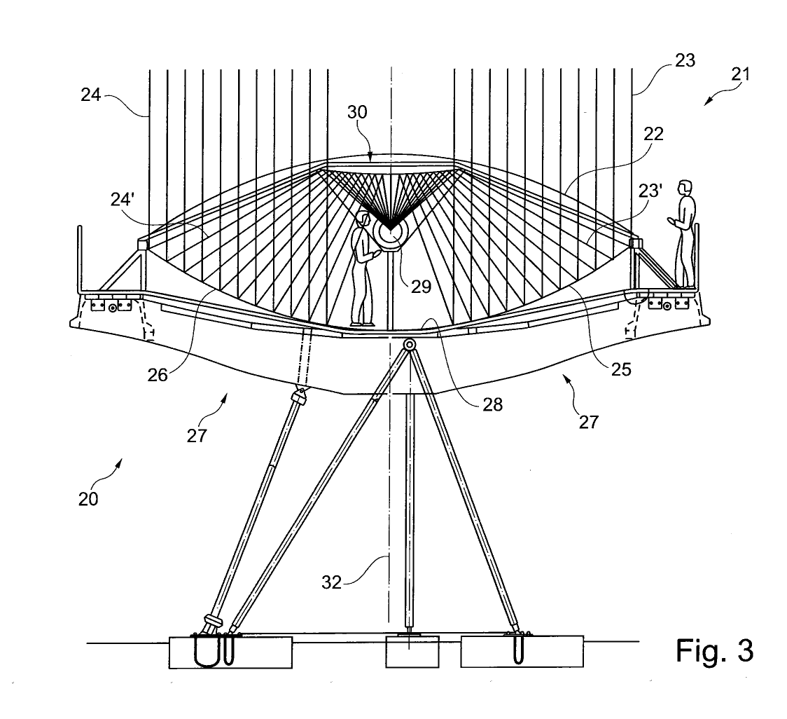

FIG. 3 shows a cross-section through a trough collector of the type shown in FIG. 1 but with a concentrator divided into two sections,

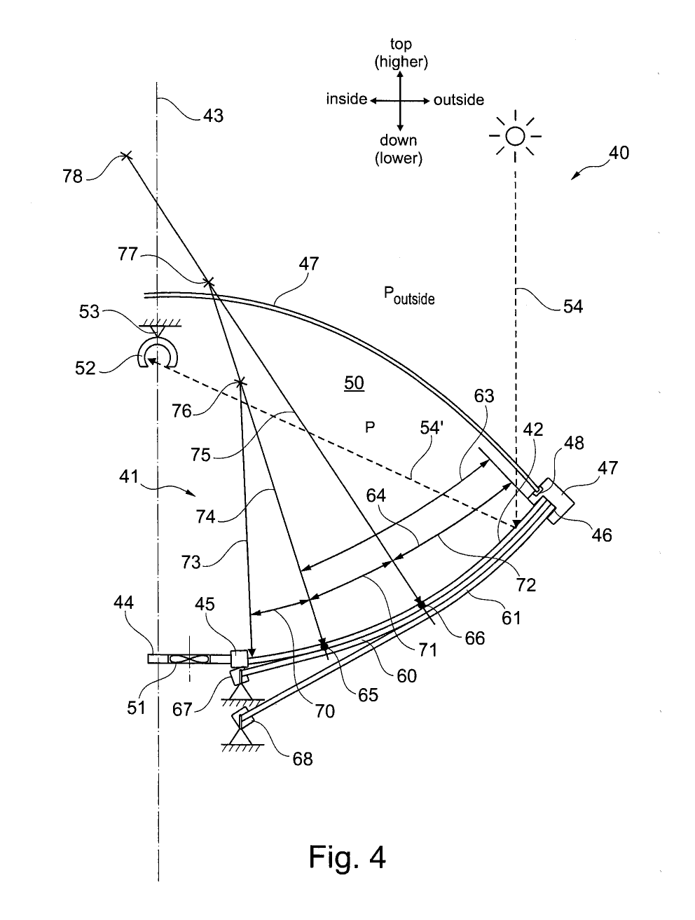

FIG. 4 shows schematically a cross-section through the pressure cell of a trough collector with a membrane arrangement according to the invention

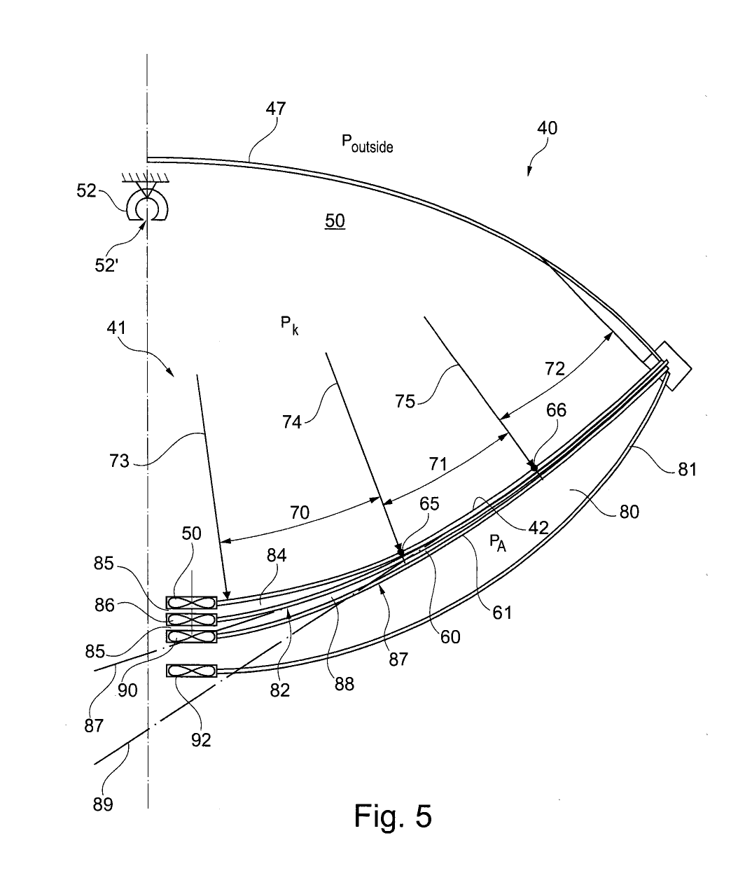

FIG. 5 shows schematically a cross-section through a further embodiment of the membrane arrangement according to the invention

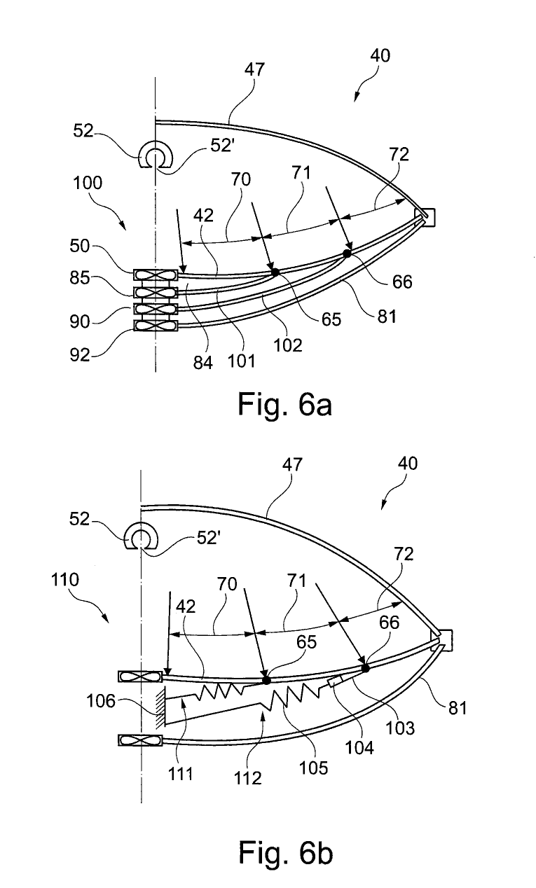

FIGS. 6a and 6b each show a cross-section through yet further embodiments and

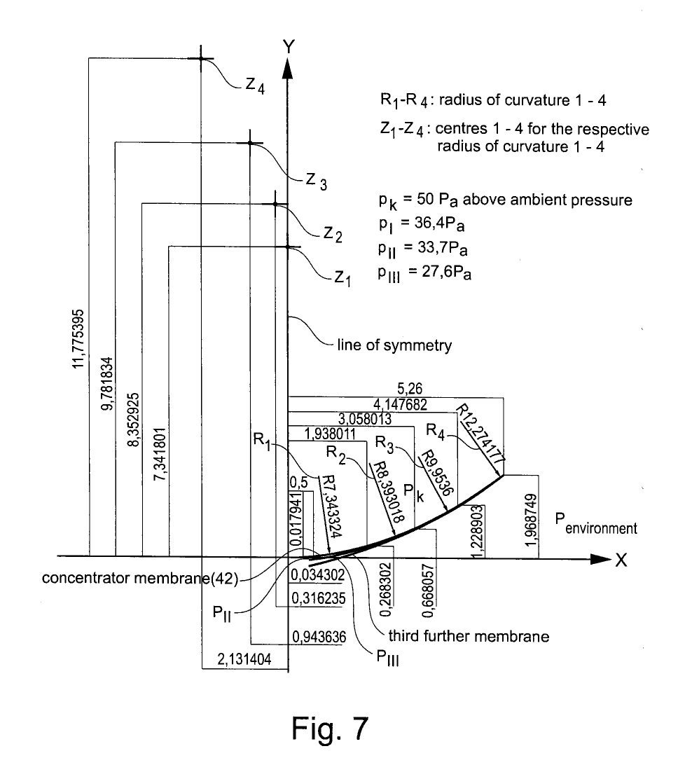

FIG. 7 shows an operative example of a membrane arrangement with four zones.

FIG. 1 shows a trough collector 1 of conventional type comprising a pressure cell 2 which has the form of a cushion and which is formed by an upper flexible membrane 3 and a lower flexible membrane 4 which is covered in the figure. The pressure cell 2 is held under operating pressure by means of a fluid channel 5, wherein a fluid channel 6 is further provided whose function is described in detail with reference to FIG. 2.

The membrane 3 is transparent for solar rays 7 which are incident inside the pressure cell 2 on a concentrator membrane 8 (FIG. 2) and are reflected by these as rays 7′ to an absorber tube 9 in which a heat-transporting medium is circulating and which removes heat concentrated by the collector. The absorber tube 9 is held by supports 10 in the focal line region of the concentrator membrane 8 (FIG. 2).

The pressure cell 2 is clamped in a frame 11 which in turn is tiltably mounted on a framework according to the position of the sun.

FIG. 2 shows schematically a cross-section through the pressure cell 2 of the collector from FIG. 1 together with the fluid channels 5 and 6. Shown is the upper transparent membrane 3 for solar rays, the lower membrane 4 and the concentrator membrane 8 which passes through the pressure cell 2. On its side facing the Sun, this has a, for example, vapour-deposited coating so that the solar rays 7 are reflected in a focal line region 13 where the absorber tube 9 is located.

The concentrator membrane 8 divides the pressure cell 2 into a concentrator chamber 15 and a compensating chamber 16. The concentrator chamber 15 is pressurised, for example, with air via the fluid channel 5 fed by a fluid pump preferably configured as a fan 17. As a result, air flows via fluid channel 6 into the compensating chamber 16. Another fluid pump preferably also configured as a fan 18 operates contrary to this direction of flow so the compensating chamber 16 is filled with air but a pressure gradient with respect to the concentrator chamber 15 always prevails. The pressure p then prevails in the concentrator chamber, the somewhat lower pressure p-Δp in the compensating chamber.

The concentrator membrane 8 is thus exposed to the operating pressure Δp which holds it [in] the operative spherically curved position.

This arrangement has the advantage that it is comparatively insensitive to wind attack and therefore allows a very thin and therefore qualitatively highly advanced concentrator membrane (see WO 2008/037108)/This, however, has the disadvantage that due to the spherical curvature not a focal line but a focal line region 13 is produced.

FIG. 3 shows a cross-section through a trough collector 20 according to the still-unpublished application CH 00462/08 comprising a pressure cell 21 and its upper transparent membrane 22 through which solar radiation 23, 24 is incident and reflected as rays 23′, 24′. Also shown is a concentrator membrane 27 consisting of two sections 25, 26, wherein the sections 25, 26 are separate from one another but are arranged symmetrically to one another with respect to the dot-dash line of symmetry 32. The central strip 28 can be walked upon, for example, for easy assembly and maintenance of the absorber line 29 running above said strip and separates the sections 25, 26 sufficiently far from one another that the shadow cast by the two-part secondary concentrator 30 does not reach the sections 25, 26 of the concentrator membrane 27.

This arrangement allows the absorber line 29 to be laid in the pressure cell 21. This is important since a conventional absorber line 9 running in the open air (FIG. 1) loses up to 100 W/m due to heat dissipation and cooling by ambient air (wind) which corresponds to a loss of 10 MW for a line length of up to 100 km (or more). Any reduction in this loss, e.g. by protection from wind cooling is therefore important and should be strived for. A further advantage of this arrangement is that the focal line region of the spherically curved sections 25, 26 of the secondary concentrator 30 is reduced by the secondary concentrator so that the advantages of the internally absorbing absorber line 29, as shown in the figure, are brought to bear.

FIG. 4 shows schematically a cross-section through the pressure cell 40 of one embodiment of the trough collector configured according to the invention, wherein the figure is shown in a somewhat exaggerated manner to illustrate the geometrical relationships.

The basic structure of the pressure cell corresponds to that of FIG. 3, i.e., the concentrator of the trough collector is configured as part of the pressure cell 40 and comprises a flexible (here: multilayer) membrane arrangement 41 which, in the embodiment shown is divided into two symmetrical section with respect to the line of symmetry 43 (which corresponds to the line of symmetry 32 of FIG. 3) which are connected to one another by means of the central strip 44. The following description refers to the right-hand section shown in the figure; it is understood that the left-hand symmetrical section is configured in the same way.

The membrane arrangement 41 comprises a concentrator membrane 42 which is covered with a reflecting layer which is not shown to ease the burden on the figure.

The concentrator membrane 42 for its part is operatively spanned on the one hand with the aid of a clamping device 45 on the central strip 44 and on the other hand with a clamping device 46 on the frame 47 of the trough collector. An upper transparent membrane 47 which is likewise fastened on the frame 47 by a clamping device 48 is also apparent.

The transparent membrane 47 together with the membrane arrangement 41 forms a concentrator chamber 50 which is held at the elevated operating pressure p compared with the external pressure pₑₓₜ by means of the fluid pump shown schematically as fan 51. Preferably p is in the range of 30 to 100 Pa, particularly preferably 50 Pa. Under such operating pressure conditions, the membrane arrangement 41 with its concentrator membrane 42 is operatively curved.

Also shown is an internal absorber tube 52, whose suspension 53 in the pressure cell 40 is indicated schematically and can be designed by the person skilled in the art according to the specific configuration of the trough collector.

A solar ray 54 is incident from above on the concentrator membrane 42 and is reflected as a ray 54′ into the interior of the absorber tube 52.

In the figure, the Sun is in the zenith and the trough collector is aligned vertically upwards. Accordingly, the Sun is designated as located at the top so that, for example, the central strip 44 is located at a specific height (further) below, or lower compared to the absorber tube 52 whilst the frame 47 is located higher and (further) outwards compared with the central strip 44 and the central strip 44 is located (further inwards) compared with the frame 47.

The figure shows a first further membrane 60 and a second further membrane 61, wherein, given by the operating pressure conditions and the spanning of the respective membrane 42, 60, 61, the concentrator membrane 42 rests on the first further membrane 60 in a first region 63 and in a second region 64 through said membrane, on the second further membrane 61.

The first region 63 extends from the outer end of the concentrator membrane 42, i.e. here from the frame 47 inwards, as far as a first predetermined line 65.

The second region 64 extends from the outer end of the concentrator membrane 42, i.e. here from the frame 47 inwards, as far as a second predetermined line 66.

The predetermined lines 65, 66, necessarily indicated as points in the cross-sectional view in the figure, extend substantially over the entire length of the membrane arrangement 41 (and therefore of the trough collector) at constant height.

At the same time, the first further membrane 60 is pre-tensioned towards a first predetermined location configured as a first anchoring 67 which lies below the inner end of the concentrator membrane 42 or below the clamping device 45. The second further membrane 61 is pre-tensioned towards a second predetermined location configured as a second anchoring 68 which is accordingly located below the first predetermined location, i.e. below the first anchoring 67.

The first and the second anchoring 67, 68 are merely indicated schematically in the figure and can be designed by the person skilled in the art according to the specific configuration of the trough collector and suitably attached to the frame or framework of the trough collector.

The first and the second predetermined location, i.e. the position of the anchorings 67, 68 are predetermined in such a manner that under operating pressure conditions and under the operating pre-tensioning forces, the concentrator membrane 42 and the first and the second further membrane 60, 61 rest upon one another as described in each case as far as the first or second predetermined line 65, 66.

A method whereby the position of the first and second predetermined line 65, 66 and the relevant pre-tensioning forces can be determined will be described in detail further below.

The first and second predetermined line 65, 66 divide the concentrator membrane 42 into three zones 70, 71, 72 starting from the central strip 44, wherein each zone 70, 71, 72 is basically spherically curved free from distortion and has an allocated radius of curvature, first radius of curvature 73, second radius of curvature 74 and third radius of curvature 75 with increasing length in each case. The innermost zone 70 71 is the most greatly curved, the following middle zone is less curved and the outer zone 72 is least curved.

It is further apparent from the figure that at the location of a predetermined line 65, 66 at which two adjacent zones 70, 71 and 71, 72 adjoin one another, the radii of curvature of the respective adjacent zones 70, 71 or 71, 72 coincide and thus the tangents to these zones at the location of the predetermined line 65, 66 also coincide. As a result, it is found that the curvature of the concentrator membrane 42 extends in a continuously differentiable manner over its entire extension, i.e. even at the location of the lines 65, 66, without any kink. This is a requirement for the smallest possible focal line region which comes close to the theoretical focal line of a parabolically curved concentrator section.

The curvature of a pressurised membrane will be described by the relation T₀=p₀R₀ known to the person skilled in the art. T₀ is the line tension (N/m, i.e. the force acting per metre of membrane length, wherein the thickness of the membrane is not important) introduced into said membrane at the edge of the membrane by its clamping. p₀ is the (difference) pressure acting on the membrane causing its spherical curvature and R₀ is the resulting radius of curvature of the membrane. At given pressure p₀, the length of the radius of curvature R₀ can therefore be adjusted by varying the line tension T₀, i.e. the force with which the membrane is pre-tensioned or clamped.

The basic line tension T_{B} now prevails in the concentrator membrane, the first line tension T₁ in the first further membrane 60 according to its pre-tension and the second line tension T₂ in the second further membrane 61 according to its pre-tension. Thus, according to the invention
in the first zone 70 of the membrane arrangement 41 the line tension is Z₁=T_{B}
in the second zone 71 of the membrane arrangement 41 the line tension is Z₂=T_{B}+T₁ and
in the third zone 72 of the membrane arrangement 41 the line tension is Z₃=T_{B}+T₁+T₂
   with the result that the radii of curvature 73 to 75 in each successive zone 70 to 72 are larger than in the previous one. By this means, according to the invention, the curvature of the concentrator membrane 42 is approximated to a parabola.

According to the invention, the curvature and extension of the zones 70 to 72 are therefore to be optimally dimensioned and achieved by means of the location of the first and second anchoring 67, 68 with the corresponding pre-tension in the relevant membrane 60, 61 so that ultimately the curvature of the concentrator membrane 42 is approximated in the best possible manner to that of a parabola with focal point at the location of the absorber tube 52 with the result that the extension of the focal line region can be minimised and the efficiency of the trough collector can be maximised.

This can be accomplished with the aid of the arcspline interpolation familiar to the person skilled in the art. By using the arcspline interpolation a given curve (in this case: the parabola to be approximated) is approximated by circular arc segments.

In the present case, the first point on the parabola to be approximated is given by its tangent as the starting position for the arcspline interpolation: this is the location of the clamping device 45 at which the concentrator membrane 42 must have a slope such that the solar ray vertically incident there is reflected into the absorber tube 51. Another point on the parabola to be approximated is the location of the clamping device 46. Finally, the parabola to be approximated is determined with the location of the absorber tube 52. Then, two further points should be assumed on this corresponding to the embodiment in the figure (which correspond to the first and second line 65, 66 here).

It then generally holds that two of the said successive points have the known coordinates xᵢ/yᵢ or xᵢ₊₁/yᵢ₊₁ and the centre of the circular arc going through these two points has the unknown coordinates x_{z}/y_{z}. The radius of curvature R pertaining to the centre is unknown whereas the slope m at the first point is again known (slope of the concentrator membrane 42 at the location of the clamping device 45).

As a result, the three equations are obtained

$${( {x}_{i} - {x}_{z} )}^{2} + {( {y}_{i} - {y}_{z} )}^{2} = {{R}^{2} \\ ( {x}_{i + 1} - {x}_{z} )}^{2} + {( {y}_{i + 1} - {y}_{z} )}^{2} = {R}^{2}$$

$$m = \frac{{x}_{1} - {x}_{z}}{{y}_{1} - {y}_{z}}$$

with the unknowns x_{z}, y_{z} and R which can be determined therefrom.

Starting from the first point at the location of the clamping device 45, the first circular arc can thus be determined, from which the slope of the tangent at the second point xᵢ₊₁/yᵢ₊₁ then follows so that the centre of curvature and the radius of curvature for the next circular arc follows with this, which leads to the next point, including its tangent, and so forth until the desired points on the parabola are connected to one another by circular arc segments and thus approximate the parabola.

Thus, however, the circular arcs are no yet optimally aligned since the locations of the first and second line 65, 66 have been arbitrarily assumed a priori.

For example, the Levenberg-Marquardt numerical optimisation algorithm makes it possible to minimize the error which exists here in the deviation of the three circular arcs from the parabola to be approximated. The error is minimised by this algorithm whereby the slope of the first tangent and the coordinates of the successive points can be freely moved as long as the sum of the height deviations of the circular arcs with respect to the parabola is minimised by the least squares method by means of their improved position.

As a result, the centres of curvature 76 to 78, the relevant radii of curvature 73 to 76 and the position of the first and second line 65, 66 are known with the result that the parabolic shape of the membrane arrangement 41 to be approximated is optimised by the three spherically curved zones 70 to 72 thus defined.

Thus, spherically curved zones 70 to 72 are provided whose width is considerably smaller than that of conventional pressure cells with the advantage that the respective focal line region is correspondingly smaller. In addition, the focal line regions of the zones 70 to 72 substantially coincide (for example, since the focal line regions are not identical due to the different geometry of the zones 70 to 72, exact coincidence is not possible). A deviation is unavoidable as previously because of the “only” optimised approximation to a parabolic shape but is so small that the inventive membrane arrangement allows a considerable increase in the efficiency of the collector.

The first anchoring 67 lies on the tangent ton the membrane arrangement at the location of the first line 65, the second anchoring 68 lies accordingly on the tangent to the location of the second line 66.

Using the predefined pressure p (preferably 50 Pa) in the concentrator chamber 50 and the radii of curvature 73 to 75 and position of the lines 65, 66 now known, the person skilled in the art can calculate the necessary pre-tension forces for each membrane 42, 60, 61 using the basic relationship T₀=p₀R₀ (see above).

The necessary pre-tension for the zone 70 (and therefore the pre-tensioning force from the anchoring 45) is obtained from the predetermined pressure p and the now-known first radius of curvature 73. The necessary pre-tension for the zone 71 similarly; the pre-tensioning force of the first anchoring 67 corresponds to the difference from the pre-tension for the zone 71 minus the pre-tensioning force from the anchoring 45. The corresponding calculation is valid for the zone 72.

In summary, by means of the first and second further membrane 60, 61, means are given for varying the line tension effective for the curvature of the concentrator membrane 42 and prevailing in said membrane arrangement 41 during operation thereof. When viewed over the length of the trough collector, the line tension is varied along the two predetermined lines 65, 66 in such a manner that the zones 70 to 72 of the membrane arrangement 41 given by the lines 65, 66 are differently curved. At the same time, the curvature is also continuously differentiable at the location of the lines 65, 66 and the focal line regions of the differently curved zones 70 to 72 substantially coincide.

As a result, according to the invention, starting from the local relationships, the person skilled in the art can determine the dimensions of the trough collector, those of the pressure cell, the position of the absorber tube and the resulting configuration of the membrane arrangement according to the invention.

Likewise, according to the invention, instead of three zones 70 to 72, the person skilled in the art can provide n such zones, i.e. only two or four or more and design them according to the calculation described above which depends on the specific circumstances such as width of the trough collector and desired optimisation of the focal line region (e.g. depending on the type of absorber provided). Likewise, the membrane arrangement according to the invention is not bound to trough collectors but can also be used in round collectors, for example, for dish Stirling systems with the advantages according to the invention. Here it should be added that small systems, e.g. up to 1 m in diameter or even smaller, can be achieved according to the invention. In such systems two zones can be sufficient for very good results.

FIG. 4 shows a membrane arrangement 41 comprising three layers, i.e. the concentrator membrane 42 as well as the first and second further membrane 60, 61 (as mentioned, only two or four and more layer could easily be used). In a further embodiment according to the invention, these membranes, insofar as they rest one upon the other, are at least partially connected to one another or configured in one piece, which can improve the intrinsic stability of the membrane arrangement. In turn, according to the specific configuration of the collector, the person skilled in the art can determine whether the membrane arrangement should consist of individual membranes placed in one another, from sections of individual membranes connected to one another or a one-piece membrane.

Likewise, it is not necessary to draw the first and/or the second further membrane 60, 61 further inwards according to the respective predetermined line 65, 66 since they only carry the concentrator membrane 42 as far as these lines 65, 66. The anchorings 67, 68 can therefore be placed closer to the lines 65, 66 or further away from them. Likewise the membrane sections (FIG. 4) provided between the anchorings 67, 68 and the lines 65, 66 can be replaced by suitable clamping means (see, for example, FIG. 6b) but in such a manner that the first and the second further membrane 60, 61 are operatively prepared (in particular uniformly over the length) at the location of their line 56, 66 and pre-tensioned in the direction of the allocated predetermined location with the correct pre-tensioning force. In this case, clamping means are provided for clamping at least one further membrane which grasp this according to the predetermined line allocated thereto and pre-tension this towards the predetermined location allocated thereto.

Furthermore, depending on the specific circumstances, the person skilled in the art can provide only the concentrator membrane with its reflecting layer in the membrane arrangement and provide clamping means which are connected to the concentrator membrane at the location of the predetermined lines 65, 66 (FIG. 4), i.e. he can vary the line tension prevailing in said membrane according to the invention (see, for example, FIG. 6a).

The elements of these different embodiments can also be suitably combined by the person skilled in the art according to the specific design of the collector.

FIG. 5 shows schematically a preferred embodiment of the present invention which combines the advantages of the collectors shown in FIGS. 2 and 3:

On the one hand, the membrane arrangement 41 divides the pressure cell 40 into a concentrator chamber 50 and a compensating chamber 80 with the advantage that then, as disclosed in WO 2008/037108, the concentrator membrane 42 can be configured to be very thin and having a uniform surface on account of the low operating pressure loading and is therefore better suitable for a highly effective reflecting coating or makes this possible for the first time. In addition, this design makes it possible for the concentrator membrane 42 to remain at rest even under wind attack although both the upper transparent membrane 47 and also the lower flexible membrane 81 become deformed under wind attack. Like those of FIG. 3 and FIG. 4, the embodiment according to FIG. 5 also makes it possible to concentrate the rays in a very small focal line region due to the membrane arrangement 41 according to the invention, allowing an absorber tube 52 having an internal absorbing surface and comparatively small inlet opening 52′ to be used for the rays, this tube being located further inside the pressure cell 40 so that heat losses can be avoided. The membrane arrangement 41 according to the invention thus allows, inter alia, a secondary concentrator according to FIG. 3 to be omitted, without needing to accept a relevant loss of efficiency.

As in FIG. 4, the figure shows a membrane arrangement 41 consisting of three layers, i.e. a concentrator membrane 42 covered with a reflecting layer, a first further membrane 60 and a second further membrane 61. The radii of curvature 73 to 75 an the predetermined lines 65, 66 which define the first, second and third zone 70 to 72 are also apparent. Again under operating pressure conditions, the zones 70 to 72 are variously curved, wherein the curvature of the concentrator membrane 42 is also continuously differentiable at the location of adjoining zones (i.e. at the location of the predetermined lines 65, 66) and the focal line regions of the variously curved zones substantially coincide at the location of the absorber zone 52 (or at the location of the inlet slit 52′).

The first further membrane 60 extends over the first predetermined line 65 and after this inwards over a first further region 82 as far as its anchoring (which is not shown further to relieve the burden on the figure). The space enclosed between the concentrator membrane 42 and the first further region 82 of the first further membrane 60 is configured in a fluid-tight manner as a first pressure chamber 84, this being terminated on the inside by a fluid-tight wall 85. Means configured as a first fan 86 are further provided for maintaining a first operating pressure p_{I} in the first pressure chamber 84.

Since the first further region 82 of the first further membrane 60 is under pressure, it is also spherically curved. Accordingly, its anchoring lies further upwards compared with that of FIG. 4, closer to the concentrator fan 50 with the consequence that the height of the compensating chamber 80 is smaller. For comparison of the heights, the first tangent 87 to the concentrator membrane 42 is indicated at the location of the first predetermined line 65, on which the anchoring of the first further membrane 60 must lie when no pressure chamber 84 is provided (see FIG. 4).

Likewise, the second further membrane 61 extends over the second predetermined line 66 and after this inwards over a second further region 87 as far as its anchoring (which is not shown further to relieve the burden on the figure). The space enclosed between the first further membrane 60 and the second further region 87 is configured in a fluid-tight manner as a second pressure chamber 88, this being terminated on the inside by a fluid-tight wall 85. Means configured as a second fan are further provided for maintaining a second operating pressure p_{II} in the second pressure chamber 88.

Since the second further region 87 of the second further membrane 61 is under pressure, it is also spherically curved. Accordingly, its anchoring lies further upwards compared with that of FIG. 4, closer to the base fan 50 with the consequence that the height of the compensating chamber 80 is smaller. For comparison of the heights, the second tangent 89 to the concentrator membrane 42 is indicated at the location of the second predetermined line 66, on which the anchoring of the first further membrane 60 must lie when no pressure chamber 84 is provided (see FIG. 4).

Without the previously described further development of the membrane 41 arrangement according to the invention with the first and/or second pressure chamber 84, 88, a disadvantageously great height, for example, for wind attack would therefore be obtained for the compensating chamber 80.

In a further embodiment, the first further membrane 60 is operatively pre-tensioned by means of clamping means provided between the first predetermined line 65 and the wall 85, wherein these clamping means are not fluid-tight with the consequence that only a single pressure chamber is provided, i.e. between the concentrator membrane 61 and the second further region 87 of the second further membrane 61. Depending on the design of the membrane arrangement 41, i.e., depending on the position of the predetermined lines 65, 66, the advantage of the small height of the compensating chamber 80 is likewise or approximately preserved. The person skilled in the art can determine suitable clamping means according to the specific conditions (see also FIGS. 6a and 6b on this matter).

The operating pressure in the concentrator chamber 50, in the first pressure chamber 84, the second pressure chamber 88 and in the compensating chamber 80 is generated and maintained by means of the basic fan 92 in the lower flexible membrane 81, the second fan 90, the first fan 85 and the concentrator fan 50. Instead of the fans 50, 85, 90, 92, other suitable fluid pumps can also be used.

Each fan 50, 85, 90, 92 conveys air in the same direction: the basic fan 92 inside the compensating chamber 80, the second fan 85 inside the second pressure chamber 88, the first fan 85 inside the first pressure chamber 84 and the concentrator fan 50 inside the concentrator chamber 50.

Due to this conveyance, a higher pressure p_{A} is formed in the compensating chamber 80 compared with the external pressure pₑₓₜ, a higher pressure p_{II} in the second pressure chamber 88 compared with the pressure p_{A} of the compensating chamber 80, a higher pressure p_{I} in the first pressure chamber 84 compared with the pressure p_{II} of the second pressure chamber 88 and a higher pressure pₖ in the concentrator chamber 50 compared with the pressure p_{I} in the first pressure chamber 84.

Accordingly, the operating pressure pₖ-p_{I} acts on the first zone 70 of the membrane arrangement 41, the operating pressure pₖ-p_{II} acts on the second zone 71 and the operating pressure pₖ-p_{A} acts on the third zone 72.

As a result, the curvature of the membrane arrangement 41 in each of the zones 70 to 72 is obtained with the line tension prevailing in each zone 70 to 72. In turn, i.e. as in the arrangement of FIG. 4, the line tension effective for the curvature of the zone 70 is equal to the pre-tension of the concentrator membrane 42, the line tension effective for the curvature of the zone 71 is equal to the sum of the pre-tensions of the concentrator membrane 42 plus the first further membrane 60 and the line tension effective for the curvature of the zone 72 is equal to the sum of the pre-tensions of the concentrator membrane 42 plus the first further membrane 60 plus the second further membrane 61.

The line tensions required are in turn obtained according to the description further above (approximation of the spherically curved zones 70 to 72 to a parabola, firstly by the arcspline interpolation, then by minimizing the errors by the Levenberg-Marquardt method, wherein the location of the absorber line, i.e. the location of the focal line region together with the clamping points of the concentrator membrane 42 form the given starting points).

At this point it should be added that the necessary pre-tension is first achieved in the zone 72 by the operating pressure pₖ-p_{A}; a value between 10 and 30 Pa, preferably 27 Pa, can be assumed for p_{A}. According to the desired curvature of the second further region 87 (see the following section), its pre-tensioning force can then be selected in conjunction with the second operating pressure. As a result, the necessary sum of the pre-tensioning forces is obtained for the first further region 82 plus the concentrator membrane 42. Finally, depending on the desired curvature of the first further region 82, its pre-tensioning can then be determined similarly in conjunction with the first operating pressure which then leads to the value of the pre-tensioning force for the concentrator membrane 42.

The person skilled in the art will then make the above-described choice of pre-tensioning force in conjunction with operating pressure according to the desired height of the anchoring on the frame or framework of the collector. He selects the respective pre-tensioning force together with the corresponding operating pressure according to the conditions given on site. At this point, it should be added that thanks to its flexibility in design, the concept of the membrane arrangement according to the invention allows the local circumstances and needs to be taken into account in the simplest possible manner, whether this be, for example, relating to larger or smaller dimensions or relating to the constructive variation of the collector itself.

The method of dimensioning the zones in the membrane arrangement described above consists in summary in that in a first step, starting from the clamping points of the concentrator membrane in the collector and the position of a heat absorber or an absorber tube, a parabolic shape to be approximated by the concentrator membrane is defined, wherein the approximation is to be achieved by n+1, preferably three, spherically curved zones of the concentrator membrane and for this n predetermined lines are assumed on the parabolic shape. In a second step, a first configuration of the n+1 spherically curved zones is determined by means of the arcspline interpolation method. In a third step, the errors given by the arcspline interpolation in the configuration of the n+1 spherically curved zones are minimised using the Levenberg-Marquardt method with free displacement of n predetermined lines with regard to their height deviation with respect to the parabolic shape to be approximated so that a second configuration of n+1 spherically curved zones is determined which is an improved approximation to the parabolic shape to be approximated.

This means that the zones according to the second configuration are minimised regarding the height deviation but with now-small height errors, large differences in the slope of the corresponding points on the circular arc of the respective zone with respect to the parabola to be approximated can still exist.

A preferred modification of the method for minimising the errors accordingly consists in modifying the Levenberg-Marquardt numerical algorithm in such a manner that the error correction is made not according to the height deviation but according to the slope deviation. Such a modification can be made by the person skilled in the art or can easily be determined by the person skilled in the art of mathematics. This results in an improved approximation of the position of the focal line regions of the zones to the focal point or the focal line of the parabola to be approximated since the reflected solar ray is more strongly defocused by incorrect slope than is the case with an incorrect height.

Accordingly, in the third step, the errors given by the arcspline interpolation in the first configuration of the n+1 spherically curved zones are minimised with regard to their slope in relation to the parabolic shape to be approximated so that a second configuration of n+1 spherically curved zones is determined which is an improved approximation to the parabolic shape to be approximated with regard to the position of its focal line regions.

A further particularly preferred modification of the method for minimising errors now consists in modifying the Levenberg-Marquardt numerical algorithm such that the error correction is additionally weighted according to the distance of the respective point from the focal point or the focal line of the membrane to be approximated whereby the distance of the respective point is determined and this distance is included as a weighting factor in the algorithm in such a manner that during the optimisation, the position, but preferably the slope (see above), of more remote points (at the expense of closer points) is approximated more accurately.

This is because a ray reflected from a more remote point with incorrect slope is more strongly defocused that a ray reflected from a point situated closer to the focal point or the focal line with the same slope error.

Accordingly, in the third step the errors given by the arcspline interpolation in the first configuration of the n+1 spherically curved zones are minimised, weighted with regard to their distance from the focal point or the focal line of the parabolic shape to be approximated, with increasing weight for further distance so that a second configuration of n+1 spherically curved zones is determined which is an improved approximation to the parabolic shape to be approximated with regard to the minimal extension of their focal line regions.

Optimal focussing is achieved according to the invention by the combination of minimising the slope errors with increasing weighting with increasing distance.

Then, in the third step the minimisation of errors is performed according to the slope and more strongly weighted with increasing distance from the focal point or the focal line of the parabolic shape to be approximated so that a second configuration of n+1 spherically curved zones is determined which is an improved approximation to the parabolic shape to be approximated with regard to the position and the minimal extension of their focal line regions.

In other words, according to the invention, it is possible for the person skilled in the art to calculate the n predetermined lines for defining the zones, the radii of curvature pertaining to each zone and then the different operating pressures with reference to the given position of the absorber line and the clamping points for the concentrator membrane in the specific case.

FIG. 6a shows schematically another embodiment of the present invention. This shows a pressure cell 40 whose membrane arrangement 100 comprises a concentrator membrane 42 in which a pre-tensioning force is introduced directly by mechanical connection at the location of the predetermined lines 65, 66 so that its curvature varies according to the invention. In contrast to the embodiments in FIGS. 4 and 5, in this membrane arrangement 100 therefore a plurality of membranes 42, 60, 61 no longer lie one above the other combined in zones. The figure shows first clamping means configured as first membrane 101 which is operatively connected to the concentrator membrane 42 at the location of the first predetermined line 65 and together with the concentrator membrane 42 forms the first pressure chamber 84, with the advantage of a small space requirement (see the description to FIG. 5). The operative connection between the clamping membrane 101 and the concentrator membrane 42 can be made, for example, by welding.

Also shown are second clamping means configured as second clamping membrane 102 which is operatively connected to the concentrator membrane 42 at the location of the second predetermined line 66 and with the first clamping membrane 101 forms the second pressure chamber 88 with the advantage of a small space requirement (see the description to FIG. 5). The operative connection between the second clamping membrane 102 and the concentrator membrane 42 can also be made, for example, by welding.

In contrast, FIG. 6b shows schematically a membrane arrangement 110, wherein the first and second clamping means are configured as spring arrangements 111 and 112 and vary the line tension effective for the curvature of the concentrator membrane 42 therein again, as in all the embodiments, along the predetermined lines 65 and 66. A stiff support 104 can be connected via a comparatively narrow membrane strip 103 which is welded to the concentrator membrane 42 to said membrane which in turn is suitably clamped by individual spring arrangements 105 which act on the frame or framework 106 of the collector. Thus, despite spring arrangements 105 arranged at a distance from one another, a uniform line force can be introduced into the concentrator membrane 42 at the location of the lines 65, 66.

FIG. 7 shows true-to-scale with the unit metres, an example for a trough collector according to the invention with a membrane arrangement with four zones. The focal line region has the coordinate x=0, y=4, the central strip has a total width of 1.0 m, the y axis lying in the line of symmetry.

As mentioned above, it is understood that the membrane arrangement according to the invention is not restricted to use in trough collectors. The embodiments presented above are also described with a view to use in large solar power plants. Equally well however, smaller collectors can be fitted with the membrane arrangement according to the invention; these may be small trough collectors or instead of trough collectors, round collectors which have a focal point or focal point region. Such collectors are possibly used for dish Stirling systems. Likewise, smaller round solar collectors having a diameter of 1 m or less can be provided with the membrane arrangement according to the invention, wherein preferably only one first further membrane is provided with such comparatively small dimensions. FIGS. 4 to 6b can be interpreted as cross-sectional drawings for round collectors from which the person skilled in the art is readily able to achieve membrane arrangements according to the invention for round collectors.

1. A solar collector comprising:
a frame;
a concentrator which is spanned operatively therein and configured as part of a pressure cell, which comprises a flexible membrane arrangement with a concentrator membrane, curved operatively under operating pressure conditions;
wherein means are provided for varying a line tension effective for a curvature of the concentrator membrane prevailing during operation in the flexible membrane arrangement along at least one or n predetermined lines in such a manner that zones of the flexible membrane arrangement thereby given are differently curved;
wherein the curvature is continuously differentiable even at the location of the predetermined lines; and
wherein a focal point or focal line regions of the differently curved zones substantially coincide.

2. The solar collector according to claim 1, wherein:
the flexible membrane arrangement comprises two sections disposed symmetrically with respect to one another;
wherein means for each section of the flexible membrane arrangement comprise a first further membrane which is spanned in such a manner that under operating pressure conditions respective section of the concentrator membrane rests on the first further membrane from its outer end as far as a first predetermined line; and
wherein the latter is pre-stressed towards a first predetermined location below an inner end of the concentrator membrane.

3. The solar collector according to claim 2, wherein:
the means for each section of the flexible membrane arrangement comprise a second further membrane which is spanned in such a manner that under operating pressure conditions the concentrator membrane rests on the second further membrane in a second region from its outer end as far as a second predetermined line through the first further membrane; and
wherein the latter is pre-stressed towards a second predetermined location below the first predetermined location of the first further membrane.

4. The solar collector according to claim 2, wherein membrane regions of at least one of the concentrator membrane and the first and second further membranes resting one upon the other are at least partially connected to one another or are configured in one piece.

5. The solar collector according to claim 2, wherein clamping means are provided for spanning at least one of the first and second further membranes which grasp the first and second further membranes according to the predetermined line allocated thereto and pre-tension said first and second further membranes towards the predetermined location allocated thereto.

6. The solar collector according to claim 2, wherein:
the first further membrane extends beyond the first predetermined line and inwards beyond a first further region and a space enclosed between the concentrator membrane and the first further region is configured in a fluid-tight manner as a first pressure chamber; and
wherein means are provided for maintaining a first operating pressure p_{I} in this chamber.

7. The solar collector according to claim 3, wherein:
the second further membrane extends beyond the second predetermined line inwards beyond a second further region and the space formed between the concentrator membrane or the first further region and the second further region is configured in a fluid-tight manner as a second pressure chamber; and
wherein means are provided for maintaining a second operating pressure p_{II} in this chamber.

8. The solar collector according to claim 5, wherein:
clamping means are provided for the first further membrane and the second further membrane extends inwards beyond the second load surface line in a second further region; and
wherein the space formed between the concentrator membrane and the second further region is configured in a fluid-tight manner as a pressure chamber in order to maintain a second operating pressure in this chamber.

9. The solar collector according to claim 1, wherein:
the concentrator membrane comprises two sections disposed symmetrically with respect to one another;
wherein the means for each section of the concentrator membrane comprise first clamping means that introduce a first line clamping force into the concentrator membrane at the location of a first predetermined line;
wherein the first clamping means comprise a first clamping membrane operatively connected to the concentrator membrane at the location of the first predetermined line;
wherein the space formed between the concentrator membrane and the first clamping membrane is configured in a fluid-tight manner as a first pressure chamber; and
wherein means are provided for maintaining a first operating pressure p_{I} in this chamber.

10. The solar collector according to claim 9, wherein:
the means for each section of the concentrator membrane comprise second clamping means which are configured to introduce a line clamping force into the concentrator membrane at the location of a second predetermined line;
wherein the second clamping means comprise a second clamping membrane operatively connected to the concentrator membrane at the location of the second predetermined line;
wherein the space formed between the first clamping membrane and the second clamping membrane is configured in a fluid-tight manner as a second pressure chamber; and
wherein means are provided for maintaining a second operating pressure p_{II} in this chamber.

11. The solar collector according to claim 1 comprising:
a circular concentrator membrane;
wherein the means comprise a first further membrane which is spanned in such a manner that under operating pressure conditions, the concentrator membrane rests on the first further membrane in a first region from its outer end as far as a first predetermined line; and
wherein said first further membrane is pre-tensioned towards a first predetermined location below an inner end of the concentrator membrane.

12. The solar collector according to claim 1 comprising:
a circular concentrator membrane;
wherein the means comprise first clamping means which are configured to introduce a first line clamping force into the concentrator membrane at the location of a first predetermined line;
wherein the first clamping means preferably comprise a first clamping membrane which is operatively connected to the concentrator membrane at the location of the first predetermined line;
wherein the space formed between the concentrator membrane and the first clamping membrane is configured in a fluid-tight manner as a first pressure chamber; and
wherein further means are provided for maintaining a first operating pressure in this chamber.

13. The solar collector according to claim 12, wherein:
the means for each section of the concentrator membrane comprise second clamping means which are configured to introduce a line clamping force into the concentrator membrane at the location of a second predetermined line;
wherein the second clamping means comprise a second clamping membrane which is operatively connected to the concentrator membrane at the location of the second predetermined line;
wherein the space formed between the first clamping membrane and the second clamping membrane is configured in a fluid-tight manner as a second pressure chamber; and
wherein further means are provided for maintaining a second operating pressure in this chamber.

14. The solar collector according to claim 7, wherein the concentrator membrane passes through a pressure cell in a fluid-tight manner and divides the pressure cell into an upper concentrator chamber for concentrator pressure and into a lower compensating chamber for compensating pressure;
wherein the concentrator pressure pₖ is higher than the first operating pressure p_{I}, which is higher than the second operating pressure p_{II} which for its part is higher than the compensating pressure p_{A}; and
wherein the compensating pressure P_{A} is higher than external pressure pₑₓₜ.

15. The solar collector according to claim 1 comprising:
an absorber tube having an external insulation;
an internal absorber chamber; and
a slitted opening provided in the external insulation for passage of concentrated solar radiation into the internal absorber chamber; and,
wherein the focal point or focal line regions of the differently curved zones lie in a region of the slitted opening.

16. A method for producing a solar collector according to claim 1, wherein in order to determine the curvature of the concentrator membrane in the respective zones in a first step starting from the clamping points of the concentrator membrane in the collector and the position of the heat absorber or an absorber tube, a parabolic shape to be approximated by the concentrator membrane is defined, wherein the approximation should be achieved by n+1, preferably three, spherically curved zones of the concentrator membrane and for this n predetermined lines are assumed on the parabolic shape;
wherein in a second step a first configuration of the n+1 spherically curved zones is determined by means of the arcspline interpolation method; and
wherein in a third step the errors given by the arcspline interpolation in the first configuration of the n+1 spherically curved zones are minimised with respect to their height deviation with respect to the parabolic shape to be approximated preferably using the Levenberg-Marquardt method whilst displacing the n predetermined lines (65, 66) so that a second configuration of n+1 spherically curved zones thus obtained is determined which is an improved approximation to the parabolic shape to be approximated.

17. The method according to claim 16, wherein in the third step using the Levenberg-Marquardt method the errors given by the arcspline interpolation in the first configuration of the n+1 spherically curved zones are minimized with respect to their slope with respect to the parabolic shape to be approximated so that a second configuration of n+1 spherically curved zones obtained is determined which is an improved approximation to the parabolic shape to be determined with regard to the position of its focal line regions.

18. The method according to claim 16, wherein in the third step preferably using the Levenberg-Marquardt method step the errors given by the arcspline interpolation in the first configuration of the n+1 spherically curved zones are minimized with respect to their distance from the focal point or the focal line of the parabolic shape to be approximated with increasing weight with further distance so that a second configuration of n+1 spherically curved zones obtained is determined which is an improved approximation to the parabolic shape to be determined with regard to the minimal extension of its focal line regions.

19. The method according to claim 17, wherein in the third step the minimization of the errors is minimized with respect to the slope and more strongly weighted with increasing distance from the focal point or the focal line of the parabolic shape to be approximated so that a second configuration of n+1 spherically curved zones is determined which is an improved approximation to the parabolic shape to be determined with regard to the position and the minimal extension of its focal line regions.
